(19) United States
(12) Patent Application Publication
(10) Pub. No.: US 2013/0074538 A1
(43) Pub. Date: Mar. 28, 2013

(54) Led Display System for Ice Rinks

(71) Applicants: Bengt Erik FORSBERG, Toronto (CA); Alan J. Wynne, Waterford (CA); James B. Mitchell, Toronto (CA); Nola Wynne, Waterford (CA)

(72) Inventors: Bengt Erik FORSBERG, Toronto (CA); Alan J. Wynne, Waterford (CA); James B. Mitchell, Toronto (CA)

(21) Appl. No.: 13/452,610

(22) Filed: Apr. 20, 2012

Related U.S. Application Data
(63) Continuation of application No. 13/228,339, filed on Sep. 8, 2011, now abandoned.
(60) Provisional application No. 61/380,972, filed on Sep. 8, 2010.

(51) Int. Cl. A63C 19/10; F21V 33/00

(52) U.S. Cl. CPC A63C 19/10; F21V 33/00
USPC 62/235; 362/249.02

(57) ABSTRACT

A display system for ice rinks comprises a panel having at least one enclosure containing a plurality of LEDs for displaying any indicia or images etc. The panel is adapted to be placed under the ice when in use. The panel is provided with a cooling apparatus for circulating a coolant through the at least one enclosure to remove heat generated by the LEDs. In one aspect, the panel includes at least one channel, within which a plurality of light emitting diodes, LEDs, are provided. The LEDs are controlled to display any indicia or images from under the ice when the panel is in use. The panel includes a manifold system for distributing a coolant through the channels so as to dissipate any heat generated by the LED, thereby, avoiding affecting the temperature of the ice.

### CROSS REFERENCE TO PRIOR APPLICATIONS

The present application is a Continuation of U.S. application Ser. No. 13/228,339, filed Sep. 8, 2011, which claims priority from U.S. Provisional application No. 61/380,972, filed Sep. 8, 2010. The entire contents of the aforementioned prior applications are incorporated herein by reference.

### FIELD OF THE INVENTION

The present invention relates to display systems for ice rinks. More particularly, the invention relates to LED display systems that are provided beneath the ice of ice rinks.

### BACKGROUND OF THE INVENTION

Ice sports such as hockey, curling etc. involve specific markings or indicia such as lines, circles and the like. Such indicia are often of different colours. Other ice sports such as figure skating, on the other hand, involve no such indicia.

Typically, an ice rink in commercial settings comprises a number of ice layers provided on a cooled concrete base. The concrete base is provided with a plurality of cooling coils embedded therein, through which a coolant is flowed. The coolant serves to maintain the surface temperature of the concrete to a desired value below the freezing temperature of water. The ice surface is provided in stages, each comprising a further layer of water that is allowed to freeze. In the first stage, a layer of water is provided over the cooled concrete and allowed to freeze so as to form an ice layer of approximately ¼ inch. This layer is then covered with a paint or other such material to provide a white surface. Two further layers of ice, each approximately ⅛ inch in thickness, are provided in series to result in a further ¼ inch of ice over the white covering. At this point, the desired indicia, such as lines, circles etc., are painted on the ice layer. The indicia are sealed and a further layer of approximately 1 inch of ice is provided. For certain applications, such as for curling, a further “pebbled” surface is provided on the ice. The use of multiple layers of ice is important in order to result in a finished surface of the desired smoothness.

As will be understood, the above described process of forming the ice slab over the cooled concrete surface requires a fair amount of time, energy and expense. For example, during the 2010 Winter Olympics (http://www.vancouver2010.com/dl/00/26/46/ice-making_{—}10dec.pdf), each of the rinks for the various sport events (speed skating, figure skating, hockey, curling etc.) took approximately 3 to 5 days to form and consisted of 20 layers of ice. One of the issues faced in commercial rinks is the requirement to melt the ice layer and re-form same when the required indicia need to be changed. For example, if an ice covering in a rink is provided for a hockey game, using the rink for a subsequent curling match requires melting of the entire rink and re-formation of the ice slab with the required markings. The process is then repeated when a hockey game is played. In addition, re-surfacing of the indicia is often required due to bleeding of the paint used to form same.

Another issue that is faced in the formation of ice rink surfaces relates to the physical properties of the ice. Specifically, as known in the art, the maintenance of a constant temperature across the entire ice surface is important in order to for the ice to have consistent properties at all locations. This is particularly true for applications in professional sports, where even the slightest temperature variation may cause reduction in performance. For this reason, the cooling systems used in rinks is specifically designed to maintain the surface of the concrete slab at a desired temperature at all times and generally at all locations. It is also known that different sports often require different and tightly controlled ice temperatures. Referring again to the 2010 Winter Olympics, the ice condition for various sports were stipulated as follows: −5.5° C. for short track speed skating; −3° C. for figure skating; and −5° to −7° C. for hockey. Such tight temperature constraints do not allow for variations over the ice surface. Indeed, it is common for the various ice layers to be formed using demineralised and filtered water in order to ensure consistent and controllable physical characteristics over the entire surface.

Various alternatives have been proposed to the use of painted indicia in ice rinks. In one such solution, it has been proposed to replace the paint used for the indicia with an illuminated display. For example, in U.S. Pat. No. 2,587,855, there is provided an illumination system that is provided underneath the ice surface. The system utilizes a plurality of incandescent bulbs, arranged in any desired manner and which may be switched on and off as needed. However, as would be understood by persons skilled in the art and as also acknowledged in the reference, the heat generated by the bulbs results in rapid melting of the surrounding ice. Another solution involves the use of light emitting diodes (LEDs) instead of incandescent bulbs. Such systems are described in U.S. Pat. Nos. 4,667,481 and 6,765,565. Although LEDs do generate much less heat, the insulative properties of the ice surrounding the LEDs and their proximity to the ice surface still results in at least some degree of heat accumulation over time. As discussed above, even this small amount of heat accumulation results in changes in the physical properties of the ice.

There exists therefore a need for a more efficient means of providing desired indicia on ice rinks that addresses at least some of the issues mentioned above.

### SUMMARY OF THE INVENTION

In one aspect, the present invention provides a display system for ice rinks comprising:
a panel comprising a plurality of light emitting diodes, LEDs, contained within at least one enclosure provided in the panel;
the panel being adapted to be positioned beneath the surface of the ice when in use, and wherein a display generated by the LEDs is adapted to be transmitted through the ice; and,
a cooling apparatus for circulating a coolant through the at least one enclosure for removing heat generated by the LEDs.

In another aspect, the present invention provides a display system for ice rinks comprising:
a panel comprising at least one channel defined by a top wall, a bottom wall and side walls;
a support provided within the at least one channel;
a plurality of light emitting diodes, LEDs, provided on the support;
a means for powering and controlling the LEDs;
a first manifold, for receiving a coolant and for distributing the coolant through the at least one channel; and,
a second manifold, for collecting the coolant from the at least one channel and for passing the coolant to a cooling means;
wherein the panel is adapted to be positioned beneath the surface of the ice when in use, and wherein a display generated by the LEDs is adapted to be transmitted through the ice.

### BRIEF DESCRIPTION OF THE DRAWINGS

The features of the invention will become more apparent in the following detailed description in which reference is made to the appended drawings wherein:

FIG. 1 is a schematic view of an illumination panel according to an aspect of the invention.

FIG. 2 is a partial end view of the panel of FIG. 1 through the line 2-2.

### DETAILED DESCRIPTION OF THE INVENTION

In the present description, reference will be made to “a panel” etc. It will be understood that the singular term “a” will include the plural such as “at least one” or “one or more”. The invention is not to be limited by the term “a”.

The present invention is primarily based upon the combination of a panel (i.e. at least one or one or more panel) comprising a plurality of programmable light emitting diodes (LEDs) arranged on a panel in any desired array format. Such panels are generally referred to as “pixel boards” and are very common for advertising displays, large format video screens and the like. In a broad aspect, the invention comprises the use of such pixel boards under the ice of an ice rink. Such panels may be of any desired shape or size. For example, the boards or panels may be provided in an elongate format, such as thin rectangles, for use as the lines on a hockey rink, as well as in the shape of the desired face-off circles, goalie creases, etc. For curling applications, the panels may be provided to form the house consisting of the desired concentric circles used in that sport.

In general, the invention comprises a system having a panel that is adapted to be placed under the ice when in use. The panel is also adapted to display any indicia or images etc. from under the ice. The panel includes at least one enclosure within which are contained a plurality of LEDs under the control of a controller. The system of the invention also comprises a cooling apparatus that serves to circulate a coolant through the panel to cool the LEDs, or, in other words, dissipate or remove the heat generated by the LEDS so as to prevent any variation in the temperature of the ice. In a preferred embodiment, the coolant is provided at the same temperature as the ice.

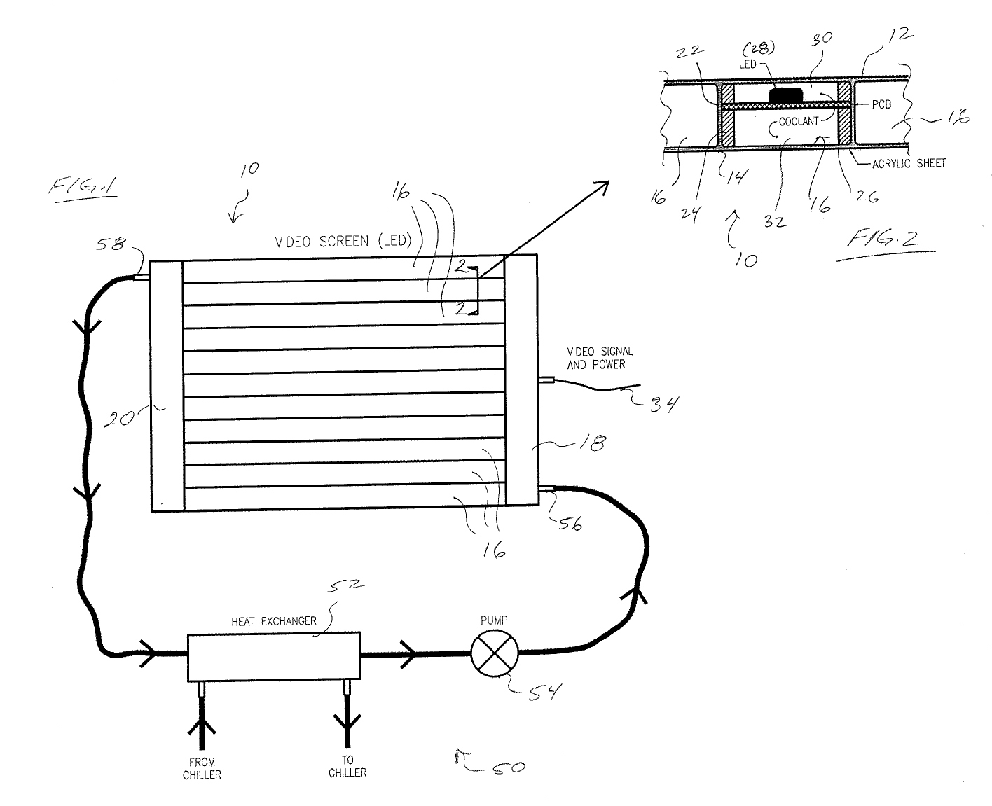

FIGS. 1 and 2 illustrate an aspect of the panel of the invention. As shown, the panel 10 comprises a generally planar sheet having a top wall 12 and a bottom wall 14. The panel further comprises a plurality of elongate channels 16 extend between two end sections or manifolds, referred to herein as first manifold 18 and second manifold 20, each of which is provided on an opposite end of the panel 10. In one aspect, the panel is formed of any type of material such as thermoplastic or thermosetting polymers etc. In one aspect, as will be apparent from the following discussion, the panel is preferably formed of a generally clear material, such as acrylic. In general, any type of material, preferably clear material, may be used to form the panels of the invention. Some of the limitations that may be taken into consideration in choosing such material would include susceptibility to damage from exposure to coolants (described further below) or to damage from exposure to the temperatures of the surrounding ice. On the latter point, it will be understood that a material that is susceptible to cracking when cooled would not be preferred for use in forming the panel. One preferred material that has been found suitable for use as the panels of the invention comprises the weather-resistant acrylic sheet manufactured by Deglas® under the name Highlux™, which is an acrylic sheet comprising the channels as discussed above and which is made from impact-modified acrylic (polymethyl methacrylate (PMMA) polymer. In a preferred embodiment, the Deglas® sheet having a thickness of 8 mm (0.315″) is used as the panel 10 of the invention.

As shown in FIG. 2, within each channel 12, is provided a LED support 22 preferably mounted between the top and bottom walls 12 and 14. In one aspect, the LED support 22 is maintained in position by end supports 24 and 26. In a preferred aspect, the LED support 22 comprises a printed circuit board, or “PCB”, to which are connected a plurality of LEDs 28. Due to the linear nature of the channels 16, the LEDs are generally provided in a linear format on the PCB. Thus, once assembled, the panel 10 provides an array of LEDs. As also shown in FIG. 2, the support or PCB 22, divides the channel 16 into an upper chamber 30 and a lower chamber 32.

The PCBs are preferably connected to a common feed 34, which provides the desired power and video feed signals. The feed 34 would, in turn, be connected to a video and power source or sources, not shown. It will be understood that the various hardware and/or software systems for powering, activating and controlling the LEDs are known in the art and any of such systems may be incorporated into the present invention. With such control systems, the LEDs on the panel 10 may controlled independently or in discrete groups and may be adapted to emit different coloured light. In this way, the LEDs may be controlled to generate any type of static or moving images. For example, when the panel is used to form a line on a hockey rink, it will comprise an elongate structure wherein all the LEDs are maintained in a single static colour, such as blue or red, during the game. The LEDs can then be either turned off or used to generated static or moving images when the game is paused. The invention is not limited to any particular format of the panel or to any particular arrangement of the LEDs provided thereon.

In the above discussion, it was noted that the support 22 preferably comprises a PCB. However, it will be understood that the support for the LEDs 28 and the electrical connections thereto may comprise separate structures.

As discussed above, the maintenance of a constant ice temperature is very important, particularly for professional sports. For this reason, the present invention has been designed to minimize or avoid the accumulation of even the minor amount of heat generated by LEDs. In this regard, and as shown in the figures, the first and second manifolds, 18 and 20, of each panel 10 are connected to a coolant system, which serves to remove any heat generated and, preferably, to maintain the ice adjacent to the panel 10 at the same temperature as all other ice across the rink.

As shown in FIG. 1, the cooling system 50, preferably comprises a heat exchanger 52 connected to a cooling unit or chiller (not shown). The cooling system 50 further includes a pump 54 that serves to circulate a coolant through the panel 10. The pump 54 pumps cooled coolant, exiting from the heat exchanger 52, into the first manifold 18 through inlet 56. The first manifold 18 distributes the coolant through all the channels 16. In particular, the manifold 18 distributes the coolant through both the upper chamber 30 and lower chamber 32 of the channel 16. As will be understood, the manifold 18 may be designed in any arrangement or format that would allow generally even flow of coolant through all the channels 18. Various structures of the manifolds of the invention would be known to persons skilled in the art. The present invention is not limited to any particular structure or arrangement of the manifolds described herein. Once the coolant flows through the channels 16, it is collected by the second manifold 20. The collected coolant is then passed through outlet 58 and subsequently to the heat exchanger 52 for cooling to a desired temperature. Although the above description has referred to the use of a heat exchanger for use in cooling the coolant, it will be understood that any other means may be used to achieve the same purpose, namely, maintenance of the coolant at a desired temperature. In one embodiment, the coolant system used for the panels 10 may be connected to the system used for cooling the concrete slab supporting the ice.

In general, in order to avoid the aforementioned problem associated with temperature variations across the ice surface, it is preferred that the coolant used for the panel 10 be at the same temperature as the concrete surface upon which the ice is formed. This will ensure an even temperature across the ice surface. Coolants for the invention may comprise any known fluid having the capability of absorbing heat. In one preferred aspect, the coolant of the invention comprises an alcohol, such as ethanol, methanol or any available lower alkyl alcohol. Various other coolants would be known to persons skilled in the art, such as ethylene glycol or other non-alcohol fluids. In one aspect, the coolant may comprise a 30% v/v solution of an alcohol in water. One of the limitations on the choice and concentration of the coolant is the effect that such solution would have on the material forming the panel 10. For example, alcohol concentrations higher than 30% may lead to deterioration of acrylic based panels.

In operation, the system of the invention comprises the placement of any number of panels 10, of the desired shape or shapes, on the concrete of the rink or over at least one of the layers of ice. It will be understood that the thickness of the panels 10 would be less than the total thickness of the ice so that a sufficiently thick layer of ice is provided over the top wall 12 of the panel 10. The LEDs provided on the installed panels would also be of any desired format. For example, if the LEDs are to be used for only forming the red line of a hockey rink, then a monochromatic LED may be used, capable of “on” and “off” states. Alternatively, if the panel is to form the display at the center of the rink, then the LEDs can be of multiple colour formats and can be arranged in any desired manner. Similarly, the controller(s) for the panels, not shown, would be of any known manner for providing the desired visual output.

As discussed above, the material forming the panels 10 is preferably clear or translucent in order to avoid interrupting the “white” colour of the ice. As would be understood, the material of the panels may also be white in colour to achieve the same purpose. In addition, it will be understood that the upper walls 12 of the panels 10 would need to be clear at least at the locations of the LEDs in order to avoid interference with the light generated thereby. The upper surface of the bottom wall 14 or the PCB may be painted white to blend in with the white colouring (mentioned above) used to form the ice.

As discussed above, the display system of the invention, comprising the LED-containing panels, are preferably used for sport applications, such as for displaying indicia etc. for hockey, curling games etc. As also discussed above, the panels may be switched off when no such indicia are required. It will also be understood that the panels of the invention may be used to display any type of visual information. For example, the panels may be used to designate information at center ice such as the name of the arena, the names of the teams, the names of the goal scorers etc. Such information may also be displayed typically where the lines (e.g. blue and red lines) are found. The panels may be used to display any type of static or moving image. It will be understood that the display shown by the panels is not limited in any way.

Although the invention has been described with reference to certain specific embodiments, various modifications thereof will be apparent to those skilled in the art without departing from the purpose and scope of the invention as outlined in the claims appended hereto. Any examples provided herein are included solely for the purpose of illustrating the invention and are not intended to limit the invention in any way. Any drawings provided herein are solely for the purpose of illustrating various aspects of the invention and are not intended to be drawn to scale or to limit the invention in any way. The disclosures of all prior art recited herein are incorporated herein by reference in their entirety.

We claim:

1. A display system for ice rinks comprising:
a panel comprising a plurality of light emitting diodes, LEDs, contained within at least one enclosure provided in the panel;
the panel being adapted to be positioned beneath the surface of the ice when in use, and wherein a display generated by the LEDs is adapted to be transmitted through the ice; and,
a cooling apparatus for circulating a coolant through the at least one enclosure for removing heat generated by the LEDs.

2. The display system of claim 1, wherein the coolant is provided at approximately the same temperature of the ice.

3. A display system for ice rinks comprising:
a panel comprising at least one channel defined by a top wall, a bottom wall and side walls;
a support provided within the at least one channel;
a plurality of light emitting diodes, LEDs, provided on the support;
a means for powering and controlling the LEDs;
a first manifold, for receiving a coolant and for distributing the coolant through the at least one channel; and,
a second manifold, for collecting the coolant from the at least one channel and for passing the coolant to a cooling means;
wherein the panel is adapted to be positioned beneath the surface of the ice when in use, and wherein a display generated by the LEDs is adapted to be transmitted through the ice.

4. The display system of claim 3, wherein the support includes the means for powering and controlling the LEDs.

5. The display system of claim 4, wherein the support comprises a printed circuit board electrically connected to the LEDs.

6. The display system of claim 3, wherein the panel comprises a plurality of channels and wherein the LEDs of the panel are arranged in an array format.

7. The display system of claim 3, wherein the coolant is provided at approximately the same temperature of the ice.

8. An ice rink comprising one or more of the display systems of claim 1.

9. An ice rink comprising one or more of the display systems of claim 3.
